(19) United States
(12) Patent Application Publication
(10) Pub. No.: US 2005/0109857 A1
(43) Pub. Date: May 26, 2005

(54) Taisty straws

(76) Inventor: David Lee Boone JR., Washington, NC (US)

Correspondence Address: DAVID LEE BOONE, 207 NOTH PIERCE STREET, WASHINGTON, NC, 27889, US

(21) Appl. No.: 10/918,791

(22) Filed: Aug. 16, 2004

Related U.S. Application Data
(60) Provisional application No. 60/496,060, filed on Aug. 18, 2003.

(51) Int. Cl. E03B 9/20; A61J 15/00; A47G 21/18; A23F 5/00

(52) U.S. Cl. 239/16; 239/33

(57) ABSTRACT

An (eatable) drinking-straw having health, environmental, vitamin, nutritional and medical benefits, and served as a food item, for purposes of vacuuming & suctioning-up foods, liquids, beverages and ingredients for consumption. A drink-straw or combination (hybrid) straw, which is taisty, eatable, consumable, palletable, dissolvable, and digestable.

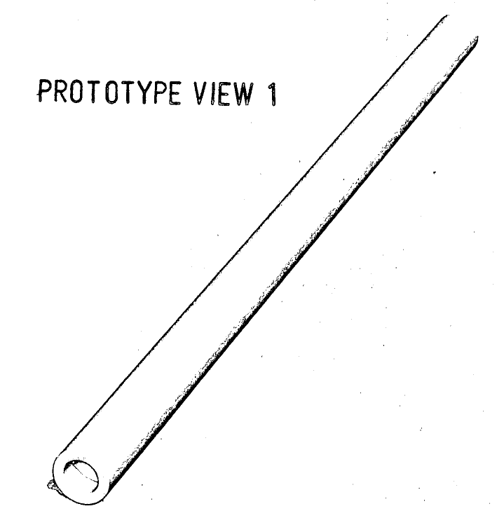

### BACKGROUND OF THE INVENTION

1. Field of the Invention

The present invention relates to drinking-straws for consuming beverages. More importantly, the present invention relates too drinking-straws that are eatable, and used for the purpose of consuming beverages. Most importantly, the present invention relates too drinking-straws, which are eatable, and having a structured make-up of environmentally-safe foods, health-foods, vitamin-foods, dairy-foods, medicine-foods, nutritious-foods, snack-foods, fast-foods, liquids and foods/ingredients . . . , and used for the purposes of suctioning-up and consuming beverages, foods, ingredients, liquids and the prior mentioned above.

2. Description of the Related Art

Various drinking-straws have been created in the past prior-art with most being formulated from costly materials, being toxic and harmful to the environment, and resulting in a huge waiste of money for the consumer.

The present eatable drinking-straw is taisty and not too be thrown away, but rather eaten after use. This present invention can be made-up of low-cost, healthy, and environmentally-safe foods, liquids & ingredients. Another advantage is that it can be manufactured as a food-item. A further advantage, is that it can be manufactured as a food-item for the purposes of consuming foods, ingredients, and liquids. Other advantages are this straws make-up and use as a gum, mint, candy, chocolate, soy, protein, rice, vitamin, dairy, antacid, medicine, flavoring, seasoning, appetiser, or nutritional food product, with the ability to deliver any of the above metioned foods, ingredients as well as others, for palletable, eatable-consumption.

### BRIEF DESCRIPTION OF THE DRAWINGS

The following represents only(one embodiment)and(one means of process), and other varieties of embodiments and future prototype design-models will become understanding reflective-models of the objects, nature, elements, features, benefits, and advantages held within the context of the claims of this invention, and in accordance with its referenced future-descriptive-drawings, thereby, being subject too changes in design, modification, and methods of fabrication & process.

View(1) is a (3-d), pictorial-view of a prototype, which in this case, was constructed with the combined use of candy, vitamin, and dairy food ingredients, having smooth, round, shaven, tip-ends, a vanilla-flavoring, and shaped, formed, molded, and designed in the form of a drinking-straw(apparatus) for purposes of delivering foods, ingredients, liquids, and beverages for purposes of taisting, consumption, and digesting. This (hybrid) straw is too be eaten as a food-item, and or, after its intent for usage.

### BRIEF SUMMARY OF THE INVENTION

The object of the invention is to provide an eatable drinking-straw or combination (hybrid)-straw from design-structured, and rendered prototype-replica's which are reflective of foods, ingredients, and lquids that formulate their makeup. Another object of the invention is to provide a food-item: which is shaped, designed, formulated, engineered and manufactured (in the same form) as a drinking-straw for the purposes of suctioning & delivery of foods and liquids(ingredients) to an individuals digestive system for the same mentioned purposes for taisting, palleting and consumtion of the prior mentioned.

The objective goals are met by combining, connecting, joining, developing, researching, processing, engineering, machining, tooling, cutting, manufacturing, distributing and marketing, but not limited to, the features, advantages, benefits, and technics of said claims 1, 2, & 3, some of which will become apparent in following detailed description, prototype view (1).

What is needed is a straw that is: eatable, durable, economical, non-toxic, not produced from plastics or such poisonous-chemicals, taisty, healthy, nutritious, medically-beneficial, and diverse (a straw served as a food, for purposes of consuming liquids, foods and ingredients).

In a prefered embodiment, prototype view (1) reflects an image(not limited in design-features), that of which is produced and or (hybridly-produced) from unlimited common foods, food-ingredients and or liquids, . . . as a food-item that being an eatable-straw, for the purposes of vacuum-delivery and consumption of eatable-ingredients, foods and liquids. It should be apparent that this product is (shown in only one embodiment), is inexpensive to produce, convenient, and is subject too changes in design, alterations, and processes of formulation, by those skilled in the art and experience of reading such specifications/drawings, etc.,.

1) A palletablet, consumable, eatable, digestable, dissolvablet, taisty, Drinking-Straw and or (hybrid)-straw, used for vacuuming, sucking, eating, drinking and consuming (hot, mild, warm, and cold) liquids, foods, ingredients and or other digestable items:
a) having special *benefits as healthy, nutritious, a dairy product, a medicine, a mint, a premium, a novelty, a candy, a gum, a vitamin, an appetiser, an antacid, a vegetable, a flavor, a fruit or dried-fruit, a solid-beverage, non-toxic, environmentally-safe, a fast-food & the ability to suction or consume any the prior mentioned above that are eatable.
b) having this eatable drinking-straw come in a variety of different flavors, designs, shapes, combinations, hybrids, lengths & widths (from tiny and thin, too jumbo extra-large) and features.
c) having this eatable drinking-straw a food-preservative, hardener, or light wax too prevent quick spoilage, when necessary.
d) some foods, beverages, materials, ingredients, products, extracts, derivatives, supplements, mixtures, hybrids, combinations, flavors, additives, dressings, sauces, liquids, nutrients etc . . . that create and or make-up this eatable-food-straw include, but are not limited to the following: candies, chocolates, soy, proteins, rices, gums, chewimg-gums, barks, sprouts, milk and dairy products and ingredients, vitamins, medicines, branches, leaves, waters, wines, beers, malts, & flavors, pasta's, fruits, frutose, sugars, mints, antacids, whey, cookies, chips, taffies, caramels, lquerish, gelatins, pastries, doughs, water-solids, liquids, plants, herbs, cereals, synthetics, meats, hydrated-foods and beverages, animal-products, jerkies, bioengineered-foods & ingredients, poultries, oils, fats, derivatives, shake-flavors, beverage-flavors, drink-flavors, non-toxic chemicals, cola's & cola-flavors, cereal-flavors, candy-flavors, dairy-flavors, derivaties & extracts, corns, wheats, oats, beans & ingredients, cigarette ingredients & products & derivatives, coffee ingredients, derivatives, & products, teas, tea-extracts & flavors, potatoe products and ingredients & derivatives, honey products and ingredients & derivatives, melons and melon-flavors & ingredients, seeds, salts, peppers, toppings, whippings, dressings, appetisers, ice & ice-creams products & ingredients, noodles, nuts, syrups, hybrid-foods/ingredients, combination-foods and products, extracts, derivatives, processed & manufactured-foods, seasonings, additives, nutrients, and such ingredients & materials, eggs & egg products & ingredients, vegetables & ingredients, straw, 's, and varieties, grains, stems, trunks & extracts, barks, leaves, roots and such, fibers (varieties), woods, powders, confeities, pills, antibiotics, biotics, gels, waxes, food-coverings & protectants, food-preservatives, doughnuts materials & ingredients, pizza's & ingredients, pizza-flavors & materials, aquacultural products, materials, plants, animals, vegetation, roots, sprouts, vegetation etc., pickles and pickle ingredients and flavors, flakes, berries, flavored-waters & beverages, spices( varieties), juices and juice-flavors, concentrates etc., creams, cool-aids & flavors, snacks and snack-flavors, ingredients, etc., tarts, cocktails, soft-drinks & flavors, seltzers, smoothies-ingredients & flavors, etc.
e) some trades, and trades of manufacture used to make or process this eatable drinking-straw include, but are not limited to the following: bioengineering, casting, molding, injecting, hand-making, sculpting, processing, compression-techniques, machine-design cutting & tooling, fabricating, crystalization-techniques, forming, baking, freezing, shaping, growing, imbeding, hybrid-producing & creation, concentrated solids and liquids manufacturing, aquaculture, hydranation, drying-techniques, blowing, whipping, extracting, derivative-processes & manufacture along with flavoring, mixing, additive-processing, chemical-production, liquid-manufacturing methods, ageing-processes, coating, fermentation-techniques, microwaving, scaping, shaving, marking, stamping, character-design art-methods, molding, casting, injecting, producing, creation & manufacture etc., hardening, preservation, waxing, and methods/processes of manufacture & distribution incorporating such techniques as prior mentioned above.

2) An eatable drinking-straw served as a food as in claim 1 wherein its said make-up is comprised of any solid-food/ingredients.

3) An eatable drinking-straw served as a food as in claim 1 wherein its said make-up is comprised of any lquid or chemical ingredients.
